(19) United States
(12) Patent Application Publication
(10) Pub. No.: US 2023/0019947 A1
(43) Pub. Date: Jan. 19, 2023

(54) Wheel Beadlock Design

(71) Applicant: Wheel Pros, LLC, Greenwood Village, CO (US)

(72) Inventor: Daniel I. Ricehouse, Phoenix, AZ (US)

(73) Assignee: Wheel Pros, LLC, Greenwood Village, CO (US)

(21) Appl. No.: 17/947,142

(22) Filed: Sep. 18, 2022

Related U.S. Application Data
(63) Continuation-in-part of application No. 17/134,409, filed on Dec. 27, 2020.
Application No. 17/134,409 is a continuation-in-part of application No. 17/134,410, filed on Dec. 27, 2020.
(60) Provisional application No. 63/245,916, filed on Sep. 19, 2021.

(51) Int. Cl. B60B 25/20; B60B 25/12; F16B 33/02; F16B 43/00

(52) U.S. Cl. CPC B60B 25/20; B60B 25/12; F16B 33/02; F16B 43/001

(57) ABSTRACT

An improved clamping mechanism to secure a tire between a bead ring and a wheel utilizing a bolt. The bolt has a ball seat that pivots within an enlarged pilot hole in the bead ring as the bolt threads engage in threaded section of the wheel, pulling the bead ring toward the wheel, eventually leveraging off a fulcrum on either the bead ring or wheel against the tire bead bundle and pressing down the tire bead to lock it in place against the wheel. As the bead ring can pivot within the enlarged pilot hole around the bolt, the bolt is not stressed. Further, the wheel comprising a safety bead and non-skid coating on the inner wall of the wheel to prevent the wheel sliding around the wheel.

### BACKGROUND OF THE INVENTION

### Field of the Invention

This invention relates to the general field of securing tires to wheels. More specifically, the invention relates to a wheel with a fulcrum, a bolt with a revolutionary ball seat, a beadlock ring with a ball seat bolt receptacle and elongated thru holes that allows the beadlock ring to be assembled to the wheel securing the tire bead, eliminating thread galling of the bolt and beadlock ring material as the beadlock ring bolts tighten the bead ring against a wheel to effectively secure a tire to the wheel, and to a method of preventing a tire from—debeading or slipping around the wheel as the vehicle accelerates or decelerates as in hard cornering.

### BRIEF DESCRIPTION OF INVENTION

In one embodiment, the invention comprises improved bolts and beadlock rings, which in turn create an improved clamping mechanism to secure a tire between the bead ring and the wheel. The bead ring includes a bead ring ball seat manufactured into it with an elongated pilot hole. The bolt has a head, a ball seat, a thread and a bolt pilot. The threads engage with a threaded section on the wheel. The threads can be any diameter and density of threads per inch. The ball seat bolt nestles with the bead ring ball seat, allowing the bead ring to pivot as the bolt threads engage with the threaded section in the wheel, pulling the bead ring toward the wheel to secure the tire bead in between the wheel and the bead ring. As the bead ring is forced down upon the wheel through rotation of the bolt, eventually the bead ring contacts a fulcrum point on the wheel, at which point the outer edge of the bead ring is leveraged against the tire bead bundle, pressing down upon the tire bead to lock it in place against the wheel. Because the bead ring can pivot about the bolt within the ball seat and elongated pilot hole without thread galling, the bolt is not stressed and increases clamping force to tire bead as in the prior art.

In another embodiment, the barrel of the wheel also has an improved safety bead that prevents the tire from moving away from the bead seat of the wheel. The area between the safety bead and the outer lip of the wheel (tire bead seat area) receives a measured (RA) surface roughness finish process to achieve the maximum co-efficient of rubber to aluminum that prevents the wheel from slipping rotationally inside the tire as the tire revolutions are quickly increased or decreased as it often the case in auto racing.

In a third embodiment, the invention provides a bolt and a spherical washer to attach the beadlock ring to the wheel. (in lieu of a ball seat bolt). Because the spherical washer has a ball seat, one of the bolts described more fully in this invention can be used to pivotally secure the beadlock ring to the tire bead bundle against the wheel.

In a fourth embodiment, the fulcrum is located on the bead ring itself, for applications where the wheel fulcrum isn't applicable. The bolt has a ball seat that pivots within an enlarged pilot hole in the bead ring as the bolt threads engage in threaded section of the wheel, pulling the bead ring toward the wheel. As the bead ring is tightened upon the wheel, eventually the bead ring contacts the fulcrum on the bead ring, at which point the outer edge of the bead ring is leveraged against the tire bead bundle and pressing down the tire bead to lock it in place against the wheel. As the bead ring can pivot within the enlarged pilot hole around the bolt eliminating thread galling, the bolt is not stressed and increases tire bead clamping force. Further, the wheel comprising an improved safety bead and anti-rotation application on the bead seat area of the wheel to prevent tire rotation or de-beading from the wheel.

### Statement of the Problem

The open edge of a tire is called a tire bead and in the middle of the tire bead is called a tire bead bundle. The tire bead bundle is usually made of metal or some other non-compressible material. In applications where tire pressure is insufficient to hold the bead of the tire in place, to effectively seal a tire to the wheel in low air pressure applications the tire bead bundle has to be clamped between the wheel and a bead ring, with several bolts extending through pilot holes in the bead ring and having threads that engage with threaded sections in the wheel. The bolt has to withstand considerable stress as it has to clamp the tire bead bundle in between the bead ring and the wheel with enough pressure such that air does not escape the tire. And tire and wheel rotate as one.

As the bead ring is tightened on the wheel, the bolt has to undergo significant stress as the angle between the bead ring and the wheel is not consistently parallel, commonly referred to as joint face angularity, even the smallest angularity errors can have a catastrophic effect of the fatigue life of a bolt. This is particularly true for the bolt head, which is often, for at least part of the process, pressing against the bead ring at an angle such that only a portion of the bolt head is touching the bead ring. This problem is particularly acute in fields such as racing and off-road tire installation, where time is essential and workers do not take time to worry about the stress they may be placing on the bolt head. One problem faced is in tire installation during bolt snapping, the bolt head is no longer keeping the tire bead bundle compressed between the bead ring and wheel; therefore, air may escape to flatten the tire, or an asymmetry of the wheel may cause other bolts to break, resulting the tire completely falling off from the wheel. When this happens in a racing car, it can be catastrophic for both the driver of that car and any nearby drivers.

Another problem faced by automobile owners, particularly race car drivers, as that when a tire is raced with low psi, there are two tendencies that can lead to catastrophic tire failure. First, with very little psi to hold the tire bead of the tire against the wheel, it is easy for the tire to move inward from the lip of the wheel and de-bead. This can lead to rapid deflation of the tire or a severe tire imbalance, causing tire failure. Second, with low psi tires, as the driver rapidly accelerates or decelerates the vehicle, the tire has a tendency to “spin around” on the wheel so the tire and wheel no longer rotate as one, as there is nothing to lock it against the barrel of the wheel. This dual rotation can put an unacceptable amount of stress on the sidewall of the tire, resulting in catastrophic failure of the tire sidewall construction.

The prior art has several examples of attempts to resolve these problems. For example, the bead ring is bolted down upon the wheel by a non-pivoting bolt where this is no pivot point for additional leverage. Another example is found in U.S. Pat. No. 9,481,205 to Rider, et. al., which illustrates a device with a threaded stud rather than a traditional bolt. However, the device neither addresses the problem of stressors upon non-pivoting bolts nor provides the additional benefits of leveraging the bead ring upon the wheel that is taught by the current invention.

Thus, there has existed a need for a better means by which a tire bead can be secured between a bead ring and a wheel and prevented tire from moving inward from the bead seat of a wheel or rotationally spinning around on the wheel.

### Statement of the Invention

In order to solve the above problems, the present invention provides a solution by utilizing a bolt about which a bead ring can pivot and a fulcrum on the wheel or, alternatively, the bead ring that can be leveraged upon to achieve a superior clamping force between a tire bead and a wheel. In addition to having a fulcrum on its inside edge, the bead ring is manufactured with a number of bead ring holes, each of which has a ball seat and an elongated pilot hole, which allows the bead ring to pivot around the bolt without thread galling of the bolt when being tightened. The bolt has a head, a ball seat, a threaded section, or thread, and a bolt pilot. The ball seat mates with the bead ring seat and the pilot hole in the bead ring is elongated greater than the diameter of the thread section of the bolt allowing the bead ring to pivot several degrees radius on either side of the bolt as the bolt threads engage threads in the wheel to prevent threading of the bead ring, pulling the bead ring toward the wheel. As the bead ring is tightened on the wheel, eventually the bead ring contacts the fulcrum on the wheel, at which point the outer edge of the bead ring is leveraged against the tire bead bundle and pressed down upon the tire bead to lock it in place against the wheel. Because the bead ring can pivot about the bolt within the elongated pilot hole, the bolt is not stressed in joint face angularity or threading as in the prior art and provides a higher clamping force more secure attachment of the tire to the wheel.

The invention additionally comprises a safety bead on the barrel of the wheel close to the inner rim. This prevents the tire from moving toward the center of the wheel, a problem particularly acute with low psi tires such as those found on sprint cars and dragsters. In between the safety bead and the inner rim, a measurable surface (RA) finish is created to the maximum coefficient of friction of rubber to aluminum, to prevent the tire from rotationally slipping around the wheel as the car accelerates and decelerates.

It is therefore an object of the present invention to provide a superior mechanism by which a tire can be attached to a wheel.

An additional object of the invention is to provide a bead ring with a ball seat and an elongated pilot hole that will allow the bead ring to pivot around a bolt without thread galling as it is screwed into a wheel.

A further object of the invention is to provide a bead ring with a fulcrum, against which a tire can be leveraged.

Another object of the invention is to provide a superior method of securing a tire in a wheel, including tires used in race cars, off-road vehicles, airplane wheels.

Another object of the invention is to provide a “safety bead” on the barrel of the wheel close to the inner rim to prevent the tire from moving toward the center of the wheel, a problem particularly acute with low psi tires.

A further object of the invention is to provide the maximum coefficient of friction surface (Measured RA) finish between the tire the wheel bead seat to prevent rotational tire-slip around the wheel as the car accelerates and decelerates as in hard cornering

A final object of the invention is to provide a bolt with a ball seat where the ball seat can mate with a bead ring seat and allow the bead ring to pivot about the bolt through an elongated-pilot hole as it is being screwed into a threaded bolt hole in a wheel to prevent joint face angularity and thread galling and improper torques causing lack of clamping force.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a perspective view of a bolt according to a preferred embodiment of the invention.

FIG. 2 is a side view of a bolt according to a preferred embodiment of the invention.

FIG. 3 is top view of a bolt according to a preferred embodiment of the invention.

FIG. 4 is a bottom view of a bolt according to a preferred embodiment of the invention.

FIG. 5 is a side view of the invention at the beginning of the beadlock tightening process.

FIG. 6 is a side view of the invention in the middle of the beadlock tightening process.

FIG. 7 is a side view of the invention at the end of the beadlock tightening process.

FIG. 8 shows side view of another embodiment of the invention with enlarged holes in the bead ring.

FIG. 9 is a side view of the embodiment of FIG. 8 as the bolt is tightened, showing the unbalanced force on the bolt head.

FIG. 10 is a side view of the embodiment of FIG. 8 as the bolt has been completely tightened.

FIG. 11 is a side view of a wheel showing the location of the fulcrum.

FIG. 12 is a perspective view of a bead ring with a bead ball seat and elongated hole.

FIG. 13 is a side view of the safety bead and anti-rotation application.

FIG. 14 is a side view of a preferred embodiment of the FIG. 20.

FIG. 15 is a cross-sectional view showing the bead ring with a fulcrum being placed next to the bead bundle and wheel.

FIG. 16 is a cross-sectional view showing the bead ring with a fulcrum pressing down on the bead bundle as the bolt threads begin to mate with the wheel threads.

FIG. 17 is a cross-sectional view showing the bead ring with a fulcrum as the bolt is tightened further, such that the fulcrum on the bead ring comes into contact with the wheel, thereby increasing leverage on the bead bundle.

FIG. 18 is a cross-sectional view showing the bead ring with a fulcrum after the bolt has been fully screwed in, such that the top of the bead ring has been fully leveraged against the bead bundle.

FIG. 19 is a cross-sectional view showing how the bead ring can be attached by the method described to the entire wheel.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

In a preferred embodiment of the present invention provides improved bolts and bead rings for creating an improved clamping mechanism to secure a tire between the bead ring and the wheel.

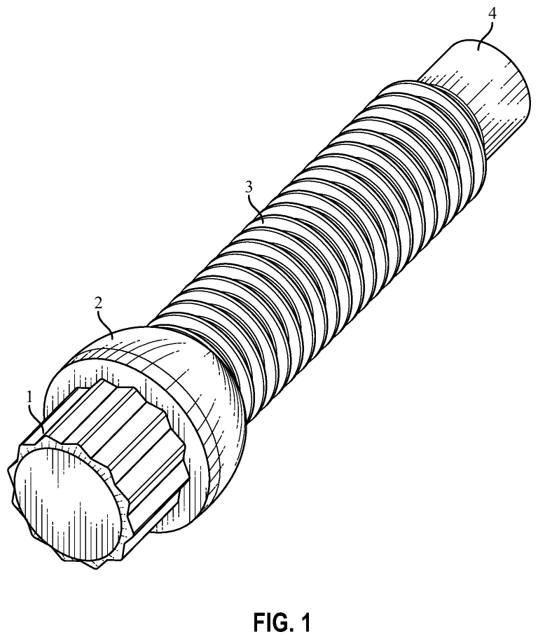

FIG. 1 is a perspective view of a bolt according to a preferred embodiment of the invention.

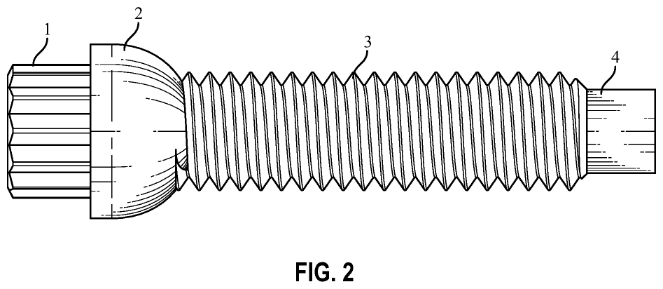

FIG. 2 is a side view of a bolt according to a preferred embodiment of the invention.

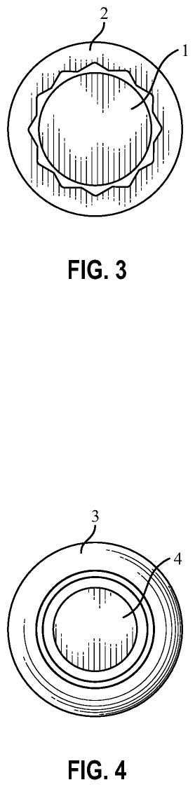

FIG. 3 is top view of a bolt according to a preferred embodiment of the invention.

FIG. 4 is a bottom view of a bolt according to a preferred embodiment of the invention.

In more details, referring now to the invention in FIG. 1, FIG. 2, FIG. 3 and FIG. 4 illustrate perspective, side, top and bottom view respectively of a bolt according to a preferred embodiment of the invention. The bolt has a head 1 (which has at least three sides, preferably twelve points), a ball seat 2 (which is the portion of the bolt that nestles in a bead ring seat), a thread 3 (which can be any diameter and with any number of threads per inch), and a bolt pilot 4. The head 1 is a hexagonal in shape. The head 1 can be made with any configuration of sides, ranging from a three-sided triangle to the 12-sided version as shown here.

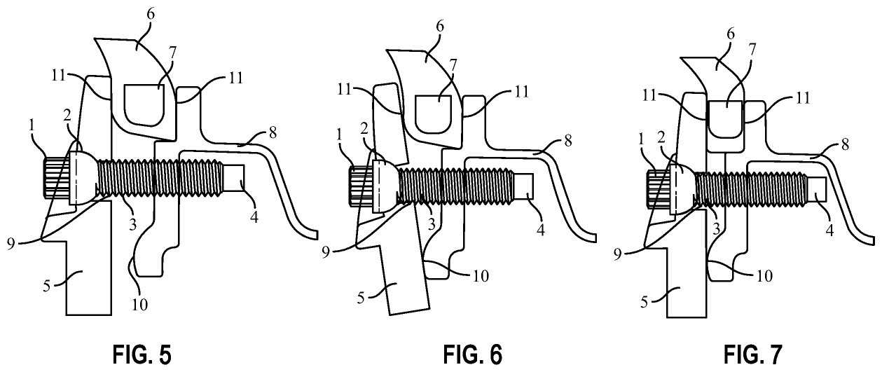

The thread 3 has a diameter. The threads can be any diameter and density of threads per inch. Some examples of bolt with varying threads diameter according to embodiments of the invention a ¼″ bolt according to one embodiment of the invention, showing two types of heads 1 the ball seat 2, the thread 3, and the bolt pilot 4. The head 1 in FIG. 5a is different from the head 1 of FIG. 5b. As shown in the FIG. 5a and FIG. 5b, the ¼″ bolt is 1.492″ and 1.5″ long respectively, the head 1 is 0.180 in length and 0.375″ in diameter, the diameter of the thread 3 is 0.250″ and the bolt pilot 4 is 0.125″ in length.

According to one embodiment of the invention, the density of threads per inch of ¼″ bolt is 20. In some embodiment of the invention, the density of threads per inch of ¼″ bolt is 28, but other thread densities are contemplated as part of this invention, in particular 5/16-18, 5/16-24, ⅜-16, and ⅜-24.

Similarly, one embodiment of the invention has a ⅜″ bolt is 2.0″ long, the head 1 is 0.250 in length and 0.563″ in diameter, the diameter of the thread 3 is 0.375″ and the bolt pilot 4 is 0.251″ in length.

According to one embodiment of the invention, the density of threads per inch of ⅜″ bolt is 16. In some embodiment of the invention, the density of threads per inch of ⅜″ bolt is 24.

Similarly, another embodiment of the invention has a 5/16″ bolt according to one embodiment of the invention, which can be 1.750″ or 1.650″ long respectively, the head 1 is 0.225 in length and 0.469″ in diameter, the diameter of the thread 3 is 0.313″ and the bolt pilot 4 is 0.188″ in length.

According to one embodiment of the invention, the density of threads per inch of 5/16″ bolt is 18. In some embodiment of the invention, the density of threads per inch of 5/16″ bolt is 24.

Another embodiment provides a 7/16″ bolt with a density of threads per inch of 7/16″ bolt of 14 or a ½″ bolt with a density of threads per inch of ½″ bolt is 13. In some embodiment of the invention, the density of threads per inch of ½″ bolt is 20.

Referring now to the invention in FIG. 5, FIG. 6 and FIG. 7 this sequence of figures illustrates the beadlock tightening process.

FIG. 5 is a side view of the invention at the beginning of the tightening process. It can be seen that in the initial engagement, the threads 3 of the bolt is engaged with threads section in the wheel 8. The ball seat 2 of the bolt is nestled in the bead ring seat of the bead ring 5. The bolt is in a 90-degree vertical configuration, so that a bit of space in the enlarged pilot hole 9, which will allow the bead ring 5 to pivot slightly around the bolt as the bead ring 5 is tightened against the wheel 8. As the tire have a tire bead 6 and a tire bead bundle 7. The tire bead 7 is made of metal or some other non-compressible material. Tire bead compressors 11 are on above and below the tire bead bundle 7, which will eventually be compressed between the wheel 8 and the bead ring 5 for sealing the tire bead bundle 7. It the goal of a bead lock to put enough pressure on the tire bead compressors 11, such that no air can escape from the inside of the tire, and that the tire is secured to the wheel.

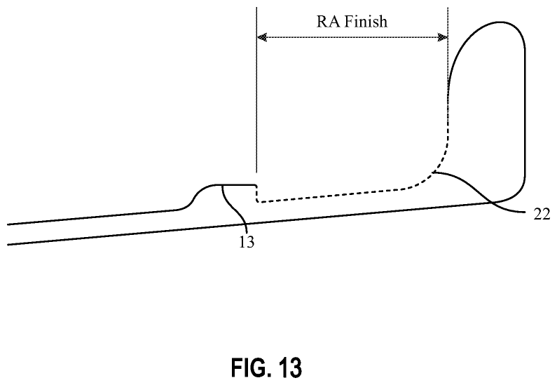

FIG. 6 is a side view of the invention in the middle of the tightening process. It can be seen that the bolt head 1 has been rotated, cause the bolt thread 3 to further engage the mating thread holes of threaded section in the wheel. This has pulled the bead ring 5 down toward the wheel 8. There is not yet enough force to compress the tire bead compressors 11, so the bead ring 5 rotates slightly in the bead ring seat (better shown in 12 of FIG. 13) until a pivot point or fulcrum 10 is contacted, which creates a fulcrum with the bead ring 5 contacting the wheel 8. The bolt in this figure has been further screwed into the wheel 8, and the bead ring 5 has pivoted slightly, in a preferred embodiment approximately 4 degrees, around the bolt, as the bolt maintains a direct, 90-degree angle with the threads in the wheel 8. This prevents part of the bolt head 1 from undergoing undesirable stress as the entire head 1 is not uniformly pressing down on the bead ring 5. The enlarged pilot hole 9 now shows no gap, as that gap has been filled by the thread 3 as the bolt pivots, but rather, a gap appears on the opposite side of the bead ring.

FIG. 7 is a side view of the invention at the end of the tightening process. The tire is squeezed and approximately 0.0125″ rubber remains on each side of tire bead 6. Upon hitting the fulcrum 10, the bead ring 5 leverages the pressure from the bolt as the bolt is further tightened, and begins to put pressure on the tire bead compressors 11 against the tire bead bundle 7. Since the tire bead bundle 7 is not compressible, the tire beach compressors 11 get flattened to effectively both seal air inside in the tire and to prevent the tired bead core 7 from escaping its confinement between the bead ring 5 and the wheel 8. Because of the use of the fulcrum 10, tires of various thicknesses can be used on the same wheel without a decrease in the security of the lock between the wheel 8 and the bead ring 5.

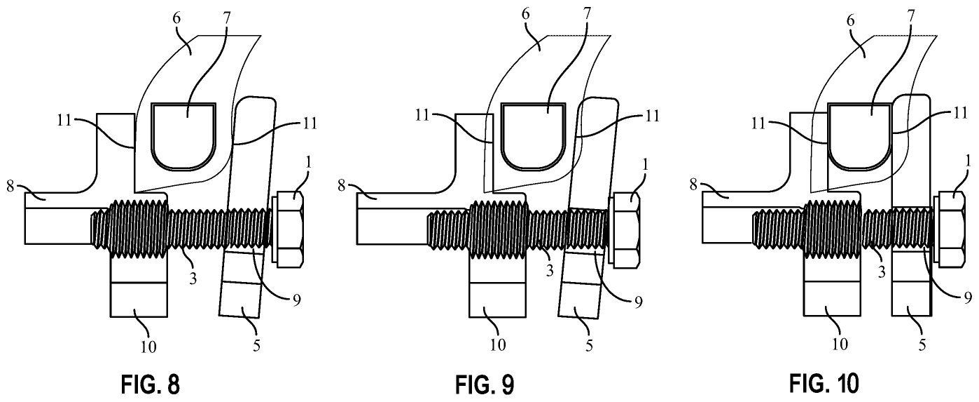

FIG. 8, FIG. 9 and FIG. 10 show side view of the prior art, in steps of securing tire bead 7 through the hole 9.

FIG. 8 shows the bolt 1 lined up with the wheel. As the bead ring 5 engages the tire bead bundle 7, the head of the bolt 1 has significantly greater pressure on the “uphill side”, resulting in irregular wear.

FIG. 9 shows the bolt head 1 from FIG. 8 continuing to have asymmetric forces applied to it.

FIG. 10. shows that after the bolt is fully inserted, the bolt head 1 is finally evenly supported by the bead ring, but only after having been torqued unevenly over the bead ring.

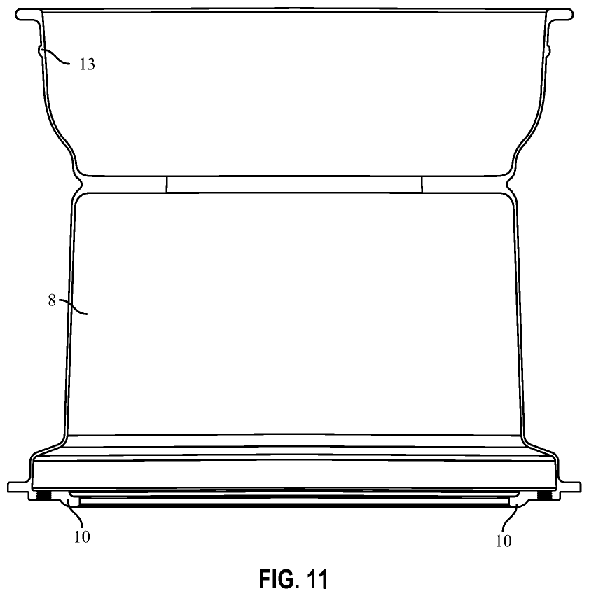

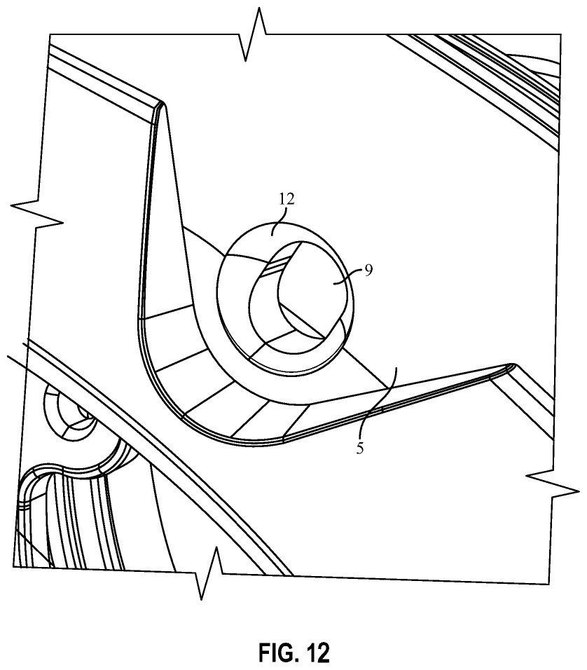

FIG. 11 is a side view of a wheel 8 showing the location of the fulcrum 10 and the safety bead 13. The barrel of the wheel 8 has a safety bead 13 that prevents the inner side of the tire from moving away from the inner rim of the wheel 8. The gap between the safety bead 13 and the inner wall has an RA coating on it that prevents the tire from slipping along the wheel 8 as the tire revolutions are quickly increased or decreased as it often the case in auto racing.

FIG. 12 is a perspective view of a bead ring 5 with a bead ring seat 12 and an enlarged pilot hole 9. It can be seen that the enlarged pilot hole 9 is not circular, but rather elongated, or “racetrack” shaped such that the bead ring 5 can pivot around the bolt, but only along a single axis. This design is very useful in minimizing stress on the bolt as it pulls the bead lock against the wheel.

FIG. 13 is a side view of the safety bead 13 and non-skid application. The invention additionally comprises a safety bead 13 on the barrel of the wheel close to the inner rim. This prevents the tire from moving toward the center of the wheel, a problem particularly acute with low psi tires such as those found on sprint cars and dragsters. In between the safety bead and the inner rim, an RA finish 22 is created, to prevent the tire from sliding around the wheel as the car accelerates or decelerates. By preventing the tire from sliding around the wheel or moving away from the rim, the combination of the safety bead and the RA finish 22 avoids the potentially catastrophic failures caused by over-stressing the sides of the tire and/or a sudden imbalance of the tire on the wheel.

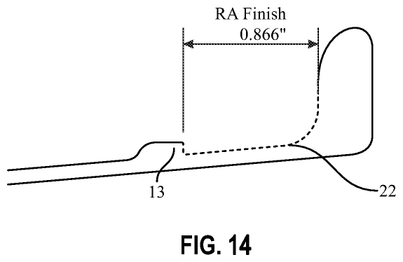

FIG. 14 shows side view of a preferred embodiment of FIG. 13 with the safety bead 13 and the RA finish for non-skid application. For an exemplary embodiment, the RA finish 22 is 0.866″ provided for 14″ rim width.

In particular, it is noted that the same function can be completed by both the “bolt” and “washer” version of the invention.

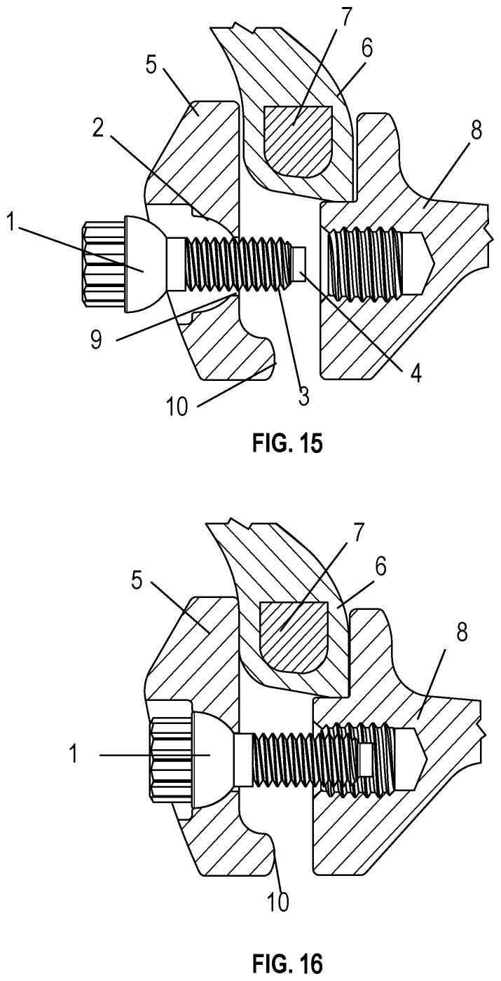

FIG. 15 is a cross-sectional view showing the bead ring 5 with a fulcrum 10 being placed next to the bead bundle 7 and wheel 8. The bead ring 5 has a fulcrum 10 on its inside edge. As the bolt 1 is threaded into female threads on the wheel 8, the fulcrum 10 will gradually rotate toward the wheel.

FIG. 16 is a cross-sectional view showing the bead ring 5 with a fulcrum 10 pressing down on the bead bundle 7 as the bolt threads 3 begin to mate with the wheel threads of the wheel 8. The upper section of the bead ring 5 comes into contact with the tire bead 6 and begins pressuring the tire bead 6 against the tire bead bundle 7 by forcing it against the wheel 8.

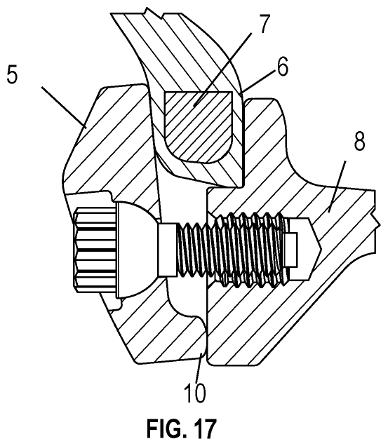

FIG. 17 is a cross-sectional view showing the bead ring with a fulcrum as the bolt 1 is tightened further, such that the fulcrum 10 on the bead ring 5 comes into contact with the wheel 8, thereby increasing leverage on the tire bead bundle 7.

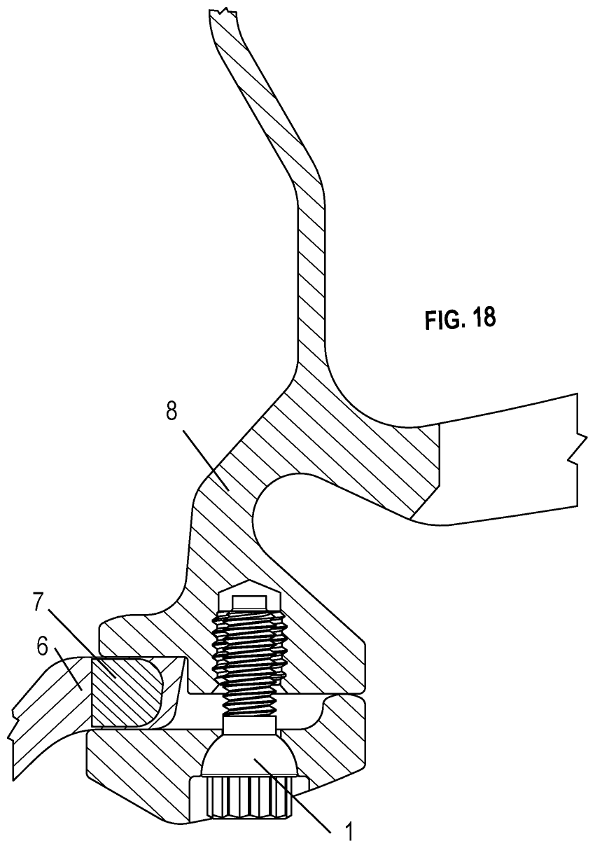

FIG. 18 is a cross-sectional view showing the bead ring with a fulcrum after the bolt 1 has been fully screwed in, such that the top of the bead ring 5 has been fully leveraged against the tire bead bundle 7 and compressed it against the tire bead 6 such that tire bead 6 has been forced above and below the tire bead 7, thereby locking the tire bead 7 into place. Because of the ball seat in the bead ring and the manner by which the bolt can rotate in the ball seat, and described earlier, the rotation of the bead ring can be accomplished with no addition stress on either the bolt or the bead ring.

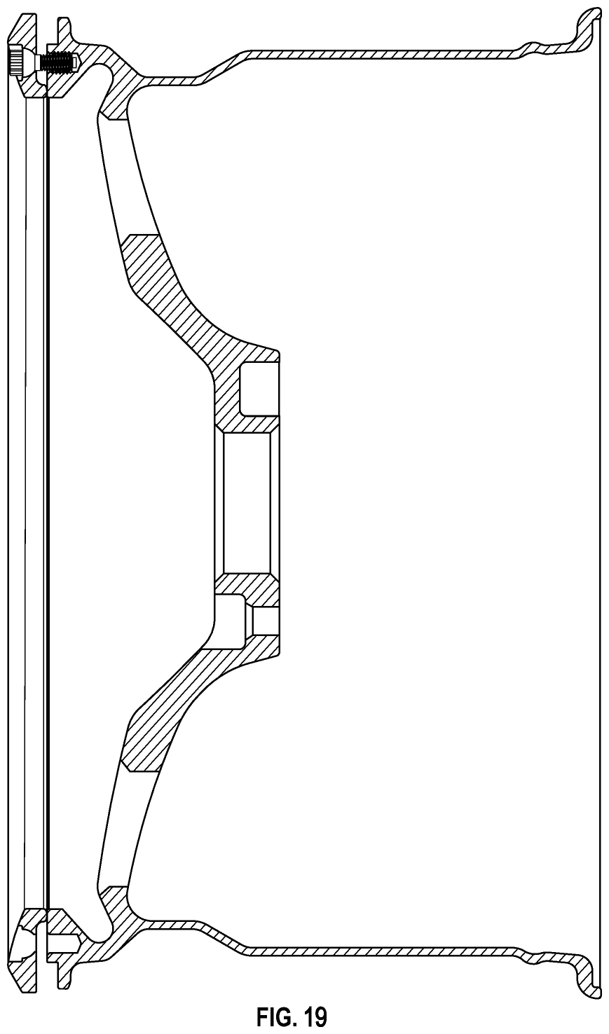

FIG. 19 is a cross-sectional view showing how the bead ring can be attached by the method described to the entire wheel.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### REFERENCE NUMBERS USED

1. Head, bolt head.
2. Ball seat
3. Thread
4. Bolt pilot
5. Bead ring
6. Tire bead
7. Tire bead bundle
8. Wheel
9. Enlarged pilot hole
10. Fulcrum
11. Tire bead compressor
12. Bead ring seat
13. Safety Bead
14. Dome Nut
15. Stud
16. Dome washer
17. Nut
18. Washer
19. Non-threaded section
20. Washer seat
21. Pivot room
22. RA finish

What is claimed:

1. A combination for attaching a tire to a wheel, consisting of: a wheel, where the wheel has a threaded section,
a bead ring, where the bead ring has a bead ring ball seat with an elongated pilot hole for bead ring attachment,
a fulcrum,
and a bolt, where the bolt has a head, a bolt ball seat, a thread and a bolt pilot.

2. The combination of claim 1, where the fulcrum is on an inside surface of the bead ring.

3. The combination of claim 1, where the fulcrum is on an outside surface of the wheel.

4. A combination for attaching a tire to a wheel, comprising: a wheel, where the wheel has a threaded section,
a bead ring, where the bead ring has a bead ring ball seat with an elongated pilot hole for bead ring attachment,
a fulcrum,
and a bolt, where the bolt has a head, a bolt ball seat, a thread and a bolt pilot.

5. The combination of claim 4, where the fulcrum is on an inside surface of the bead ring.

6. The combination of claim 5, where the bead ring seat has a bead ring seat shape, and the bead ring seat shape is racetrack shaped, where the bolt ball seat nestles with the bead ring ball seat and the elongated pilot hole in the bead ring, allowing the bead ring to pivot around the bolt when the bolt tightens the bead ring against the wheel, where the thread of the bolt engages with threaded section of the wheel, further a fulcrum on the bead ring to increase clamp load pressure on a tight tire seal between the bead ring and the wheel, when the fulcrum touches the wheel, where the bead ring and the wheel retain a tire with a tire bead bundle, where the tire bead bundle is retained between the bead ring and the wheel.

7. The combination of claim 6, where the head of the bolt has a shape, and the shape is hexagonal.

8. The combination of claim 7, where the thread of the bolt has a diameter, and the thread diameter is selected from the group consisting of ¼″, ⅜″, and 5/16″.

9. The combination of claim 7, where the thread of the bolt has a thread density, and the thread density is between 16 and 24 threads per inch.

10. The combination of claim 4, where the fulcrum is on an outside surface of the wheel.

11. The combination of claim 10, where the bead ring seat has a bead ring seat shape, and the bead ring seat shape is racetrack shaped, where the bolt ball seat nestles with the bead ring ball seat and the elongated pilot hole in the bead ring, allowing the bead ring to pivot around the bolt when the bolt tightens the bead ring against the wheel, where the thread of the bolt engages with threaded section of the wheel, further engaging the fulcrum on the outside surface of the wheel to increase clamp load pressure on a tight tire seal between the bead ring and the wheel, when the fulcrum touches the bead ring, where the bead ring and the wheel retain a tire with a tire bead bundle, where the tire bead bundle is retained between the bead ring and the wheel.

12. The combination of claim 11, where the head of the bolt has a number of sides, and the number of sides is greater than 3.

13. The combination of claim 12, where the thread of the bolt has a diameter, and the thread diameter is between ¼″ and 5/16″.

14. The combination of claim 13, where the thread of the bolt has a thread density, and the thread density is between 14 and 24 threads per inch.

15. A composition for attaching a tire to a wheel, comprising;
a wheel, where the wheel has a threaded section,
a bead ring, where the bead ring has a bead ring seat and an enlarged pilot hole,
a bolt, where the bolt has a head, a bolt ball seat, a thread and a bolt pilot, and
a tire, where the tire has a tire bead and a tire bead bundle,
where the ball seat nestles in the bead ring seat and the enlarged pilot hole in the bead ring, and, firstly, the thread of the bolt engages the threaded section, the head is rotated to further pull the bead ring toward the wheel, where the tire bead and the tire bead bundle extend into a gap between the wheel and the bead ring, where, secondly, as the head is further rotated, the tire bead is compressed between the bead ring and the wheel, where eventually the wheel contacts the bead ring at a fulcrum, where the enlarged pilot hole allows the bead ring to pivot around the bolt as an angle between the bead ring and the wheel changes, where, thirdly, after a pivot point is reached, further tightening of the head causes the bead ring and the wheel to further compress the tire bead through leverage, where, fourthly, the bead ring and the wheel put more pressure on tire bead compressors on either side of the tire bead bundle, such that the tire is effectively sealed within a gap between the tire bead and the wheel.

16. The composition of claim 15, where the bead ring seat has a bead ring seat shape, and the bead ring seat shape is racetrack shaped.

17. The composition of claim 16, where the fulcrum is on an inner surface of the bead ring.

18. The composition of claim 16, where the fulcrum in on an outer surface of the wheel.

19. A composition for attaching a tire to a wheel, comprising a wheel, a bead ring, a washer, a bolt and a tire, where the bolt has a head, a ball seat, a thread and bolt pilot where the washer has a washer seat attached to the bead ring to pivotally secure the bead ring over the tire against the wheel.

20. The composition of claim 19, where the wheel additionally comprises a fulcrum, against which the bead ring is leveraged.

21. The composition of claim 20, where the wheel further comprises a safety bead that prevents an inner side of the tire from moving away from an inner wall of the wheel or sliding around the wheel, where a gap wheel surface between the safety bead and the outer wheel lip has a surface provision to maximize the co-efficient of rubber to aluminum (measured RA), the surface provision prevents the tire from slipping rotationally around the wheel when the tire revolutions are quickly increased or decreased.

22. A method of securing a tire bead bundle between a bead ring and a wheel, comprising the steps of, first, obtaining a wheel, where the wheel has a threaded section, a bead ring, where the bead ring has a bead ring ball seat with an elongated pilot hole for bead ring attachment, a fulcrum, and a bolt, where the bolt has a head, a bolt ball seat, a thread and a bolt pilot, second, inserting the tire bead between the wheel and the bead ring, third, inserting the bolt and rotating the bolt such that the thread of the bolt engages the threaded section of the wheel, fourth, rotating the bolt a further amount such that there is an increase clamp load pressure between the bead ring and the wheel, fifth, rotating the bolt an additional amount such the bead ring and the wheel retain the tire bead bundle, where the tire bead bundle is retained between the bead ring and the wheel.

23. The method of claim 22, where the fulcrum is on an inside surface of the bead ring.

24. The combination of claim 23, where the bead ring seat has a bead ring seat shape, and the bead ring seat shape is racetrack shaped, where the bolt ball seat nestles with the bead ring ball seat and the elongated pilot hole in the bead ring, allowing the bead ring to pivot around the bolt when the bolt tightens the bead ring against the wheel, where the thread of the bolt engages with threaded section of the wheel, further a fulcrum on the bead ring to increase clamp load pressure on a tight tire seal between the bead ring and the wheel, when the fulcrum touches the wheel, where the bead ring and the wheel retain a tire with a tire bead bundle, where the tire bead bundle is retained between the bead ring and the wheel.

25. The combination of claim 22, where the fulcrum is on an outside surface of the wheel.

26. The combination of claim 25, where the bead ring seat has a bead ring seat shape, and the bead ring seat shape is racetrack shaped, where the bolt ball seat nestles with the bead ring ball seat and the elongated pilot hole in the bead ring, allowing the bead ring to pivot around the bolt when the bolt tightens the bead ring against the wheel, where the thread of the bolt engages with threaded section of the wheel, further engaging the fulcrum on the outside surface of the wheel to increase clamp load pressure on a tight tire seal between the bead ring and the wheel, when the fulcrum touches the bead ring, where the bead ring and the wheel retain a tire with a tire bead bundle, where the tire bead bundle is retained between the bead ring and the wheel.
